(19) United States
(12) Patent Application Publication
(10) Pub. No.: US 2018/0167770 A1
(43) Pub. Date: Jun. 14, 2018

(54) COMPUTER-READABLE RECORDING MEDIUM, TRANSMISSION CONTROL METHOD AND INFORMATION PROCESSING DEVICE

(71) Applicant: FUJITSU LIMITED, Kawasaki-shi (JP)

(72) Inventor: Susumu Koga, Kawasaki (JP)

(73) Assignee: FUJITSU LIMITED, Kawasaki-shi (JP)

(21) Appl. No.: 15/799,168

(22) Filed: Oct. 31, 2017

(30) Foreign Application Priority Data
Dec. 14, 2016 (JP) 2016-242736

(51) Int. Cl. H04W 4/02

(52) U.S. Cl. CPC H04W 4/021; G06F 3/011

(57) ABSTRACT

A non-transitory computer readable recording medium stores therein a program that causes a computer to execute a process of transmitting a distribution request to distribute AR content to a distribution server in response to detection of a given event, the process including: transmitting a distribution request to distribute AR content to a given terminal when it is detected that there is the given terminal in a given concentric zone about a terminal.

### CROSS-REFERENCE TO RELATED APPLICATION

This application is based upon and claims the benefit of priority of the prior Japanese Patent Application No. 2016-242736, filed on Dec. 14, 2016, the entire contents of which are incorporated herein by reference.

### FIELD

The embodiment discussed herein is related to a computer-readable recording medium, a transmission control method, and an information processing device.

### BACKGROUND

Recently, augmented reality (AR) technologies have been proposed in which positioning is performed on a terminal by using a global positioning system (GPS) and an object is displayed in a superimposed manner on an image that is captured by a camera. For example, a terminal displays an object that is acquired in advance, such as a set of AR content based on position information obtained by the positioning among sets of AR content, in a superimposed manner on a captured image. It is also proposed that multiple users who view AR content are managed according to corresponding groups and users who belong to different groups share the same AR content. It is also proposed that, when AR content gets viewed by multiple users, the same AR content gets viewed by users with a short distance between the users. It is also proposed to, when displaying AR content on a terminal, lower frequency of the positioning when there is a long distance between the user and the AR content and increase frequency of the positioning when there is a short distance between the user and the AR content.

Patent Document 1: International Publication Pamphlet No. WO 2013/145614

Patent Document 2: Japanese Laid-open Patent Publication No. 2011-86272

Patent Document 3: Japanese National Publication of International Patent Application No. 2014-531632

### SUMMARY

According to an aspect of an embodiment, a non-transitory computer readable recording medium stores therein a program that causes a computer to execute a process of transmitting a distribution request to distribute AR content to a distribution server in response to detection of a given event, the process including: transmitting a distribution request to distribute AR content to a given terminal when it is detected that there is the given terminal in a given concentric zone about a terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary configuration of a transmission control system according to an embodiment;

FIG. 2 is a diagram illustrating an exemplary display of AR content;

FIG. 3 is a diagram illustrating an exemplary radar chart;

FIG. 4 is a diagram illustrating another exemplary display of AR content;

FIG. 5 is a diagram illustrating an exemplary content storage unit;

FIG. 6 is a flowchart illustrating an exemplary transmission control process according to the embodiment;

FIG. 7 is a flowchart illustrating an exemplary distribution control process; and

FIG. 8 is a diagram illustrating an exemplary computer that executes a transmission control program.

### DESCRIPTION OF EMBODIMENT

When sets of AR content are set in positions in a wide area, storing the large volume of the sets of AR content in advance in a terminal of a user reduces the capacity of a storage unit of the terminal. When each of multiple users acquires AR content in the vicinity from a server as needed to deal with the reduction, the amount of communication between the terminals and the server increases. When a terminal communicates with the server by using, for example, a third generation mobile communication system and a mobile phone line, for example, according to long term evolution (LTE), the volume of communication increases and accordingly power consumption of the terminal increases.

Preferred embodiments of the present invention will be explained with reference to accompanying drawings. The embodiments do not limit the disclosed technology. The following embodiments may be combined as appropriate as long as no inconsistency is caused.

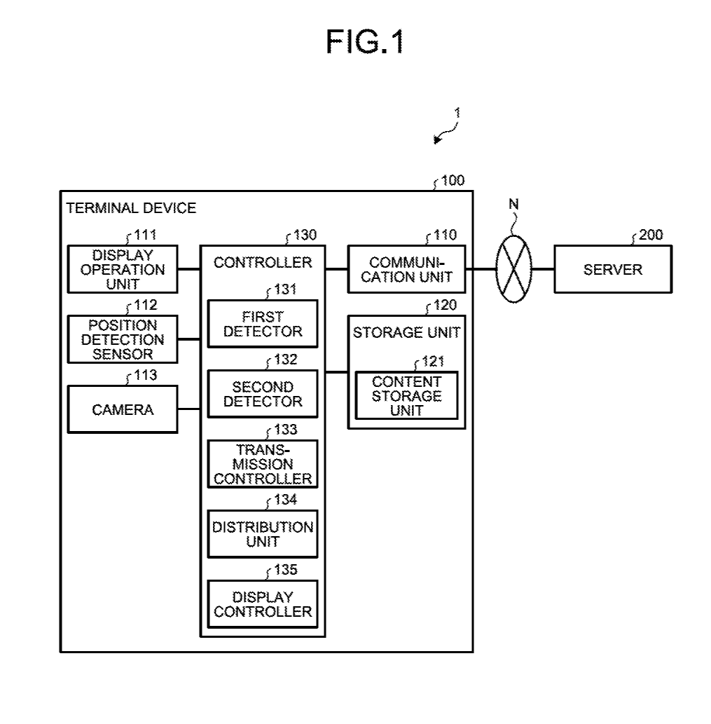

FIG. 1 is a block diagram illustrating an exemplary configuration of a transmission control system according to an embodiment. A transmission control system 1 illustrated in FIG. 1 includes a terminal device 100 and a server 200. FIG. 1 exemplifies one of the terminal devices 100; however, the number of the terminal devices 100 is not limited and the transmission control system 1 may include any number of terminal devices 100. The terminal device 100 and the server 200 are connected with each other via a network N such that the terminal device 100 and the server 200 are able to communicate with each other. For the network N, any type of communication network, such as the Internet, a local area network (LAN) or a virtual private network (VPN), may be used regardless whether the network is wired or wireless.

The terminal device 100 is, for example, an information processing device that is held by hand and operated by a user. For the terminal device 100, for example, a mobile communication terminal, such as a tablet terminal or a smartphone may be used. In the following descriptions, the terminal devices 100 may be simply referred to as terminals. In the following descriptions, to describe the terminal devices 100 separately as a terminal and another terminal, the terminal devices 100 may be referred to as a terminal 100a that is a terminal and a terminal 100b that is another terminal. The terminal 100b is an exemplary given terminal that executes the same type of application as that executed by the terminal 100a.

In response to detection of a given event, the terminal device 100 transmits a request to distribute AR content to a distribution server, that is, the server 200. When the terminal 100a detects a given terminal that is the terminal 100b, which is another terminal, in a given concentric zone about the terminal 100a, the terminal 100a transmits a request to distribute AR content to the given terminal, that is, the terminal 100b. Accordingly, the terminal device 100 is able to curb power consumption of the terminal device 100.

The server 200, for example, includes a database that manages AR content for checking equipment in a factory. The server 200 transmits AR content to the terminal device 100 via the network N in response to a request from the terminal device 100. The server 200 is an exemplary distribution server.

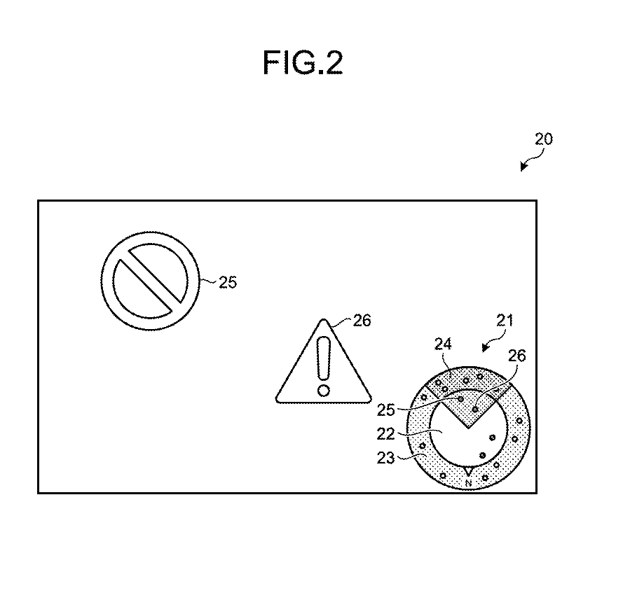

An exemplary display screen that is displayed on the terminal device 100 will be described. FIG. 2 is a diagram illustrating an exemplary display of AR content. As illustrated in FIG. 2, a radar chart 21 and sets of AR content 25 and 26 are displayed on a display screen 20. On the radar chart 21, positions of sets of AR content are displayed around the user. The radar chart 21 includes a display area 22 in which AR content is displayed in the display screen 20 and a pre-display area 23 that is set around the display area 22. In the radar chart 21, the sets AR content are represented by dots.

The AR content in the pre-display area 23 is not displayed in the display screen 20 even when the user turns to the AR content; however, when the user gets more close to the AR content, the AR content is displayed in the display screen 20. The radar chart 21 includes a field-of-view 24 indicating the field of view of the user. In other words, AR content in the display area 22 and in the field-of-view 24 in the radar chart 21 is displayed on the display screen 20. As the dots corresponding to the sets of AR content 25 and 26 are in the field-of-view 24 on the display screen 20 illustrated in FIG. 2, the sets of AR content 25 and 26 are displayed on the display screen 20.

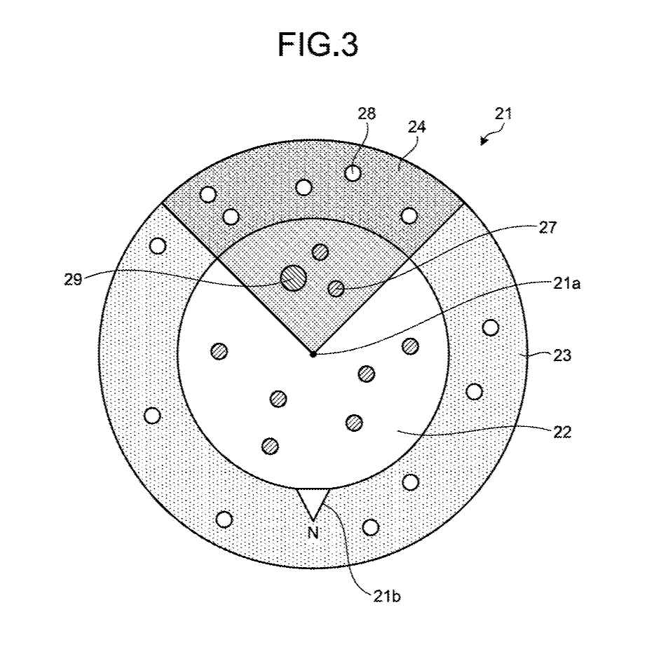

FIG. 3 is a diagram illustrating an exemplary radar chart. FIG. 3 illustrates the enlarged radar chart 21. The radar chart 21 consists of a circle about a user position 21a. The radar chart 21 includes the display area 22 that is a circle whose radius is a given distance from the user position 21a and the pre-display area 23 that is an area surrounded by the circle of the display area 22 and a circle larger than the display area 22. An orientation sign 21b indicating the north is displayed on the radar chart 21. The orientation sign 21b may be movable according to the move and orientation of the user.

In the display area 22 and the pre-display area 23, for example, multiple dots indicating sets of AR content are displayed and, for example, the sets of AR content 27 in the display area 22 and in the field-of-view 24 are displayed on the display screen. On the other hand, sets of AR content 28 in the pre-display area 23 and in the field-of-view 24 are not displayed on the display screen. AR content 29 indicated by a dot larger than other dots indicates that the AR content is being edited. Editing AR content includes, for example, changing the position and size of the AR content and adding information.

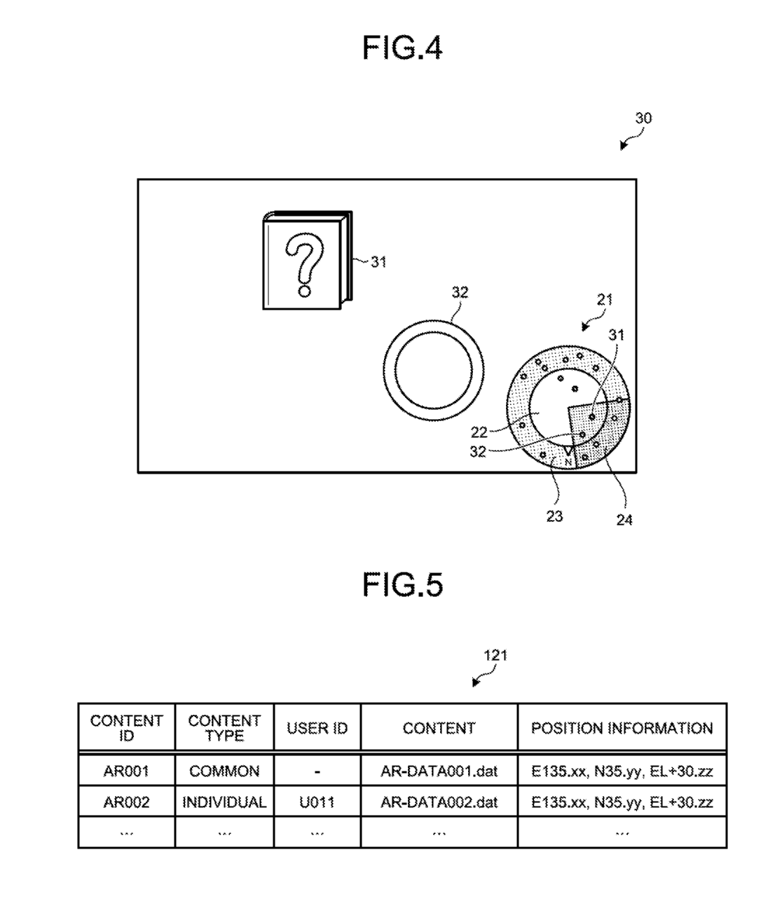

FIG. 4 is a diagram illustrating another exemplary display of AR content. As illustrated in FIG. 4, the orientation of the user on a display screen 30 is different from that on the display screen 20 illustrated in FIG. 2. In other words, the display screen 30 is a display screen in the case where the user has turned from the south to the northwest. On the radar chart 21 on the display screen 30, there are dots corresponding to sets of AR content 31 and 32 in the display area 22 and in the field-of-view 24. For this reason, the sets of AR content 31 and 32 are displayed on the display screen 30. Note that the AR content in the pre-display area 23 is not displayed.

A configuration of the terminal device 100 will be described. As illustrated in FIG. 1, the terminal device 100 includes a communication unit 110, a display operation unit 111, a position detection sensor 112, a camera 113, a storage unit 120, and a controller 130. The terminal device 100 may include various functional units of a known computer, such as various input devices and sound output devices, in addition to the functional units illustrated in FIG. 1.

The communication unit 110 is, for example, implemented by a third-generation mobile communication system, a mobile phone line according to, for example, LTE, a communication module, such as a wireless LAN, etc. The communication unit 110 is a communication interface that is connected to the server 200 via the network N and that manages communication of information with the server 200. The communication unit 110 is the communication interface that also manages communication with the terminal 100b, which is another terminal, not via the network N. The communication unit 110 transmits a distribution request that is input from the controller 130 to the server 200 or the terminal 100b that is in the vicinity of the terminal 100a via the network N. When transmitting a distribution request to the server 200, the communication unit 110 transmits the distribution request via the network N. When transmitting a distribution request to the terminal 100b, the communication unit 110 transmits the distribution request not via the network N.

The communication unit 110 receives AR content according to the distribution request from the server 200 or the terminal 100b that is in the vicinity of the terminal 100a. When receiving the AR content according to the distribution request from the server 200, the communication unit 110 receives the AR content via the network N. When receiving the AR content according to the distribution request from the terminal 100b, the communication unit 110 receives the AR content not via the network N. The communication unit 110 outputs the received AR content to the controller 130.

The display operation unit 111 serves as a display device for displaying various types of information and as an input device that accepts various operations from the user. For example, the display operation unit 111 serving as the display device is implemented by, for example, a liquid crystal display. The display operation unit 111 serving as the input device is implemented by, for example, a touch panel. In other words, the display device and the input device are integrated into the display operation unit 111. The display operation unit 111 outputs an operation that is input by the user as operation information to the controller 130.

The position detection sensor 112 is a sensor that detects the position and orientation of the terminal device 100. The position detection sensor 112, for example, includes a GPS receiver that detects the position and an accelerometer, a gyro sensor and an orientation sensor that detect the orientation. The position detection sensor 112 generates position information containing the longitude, latitude and altitude on the basis of GPS signals that are received by the GPS receiver. The position detection sensor 112 detects the orientation of the terminal device 100 by using the accelerometer, the gyro sensor and the orientation sensor and generates orientation information from information about the detection orientation. When a detection instruction is input from the controller 130 to the position detection sensor 112, the position detection sensor 112 starts generating potion information and orientation information. For the accelerometer, for example, a piezo-resistive or capacitive 3-axis accelerometer may be used. For the gyro sensor, for example, a vibrating gyro sensor may be used. For the orientation sensor, for example, a magnetic sensor may be used. The position detection sensor 112 outputs the generated position information and orientation information to the controller 130. The position detection sensor 112 may be a sensor corresponding to another positioning system.

The camera 113 is an exemplary imaging device. For example, the camera 113 is provided on the back surface of the terminal device 100, that is, on the surface opposite to the display operation unit 111, and images the surroundings. The camera 113, for example, captures images by using, as an imaging device, a complementary metal oxide semiconductor (CMOS) image sensor or a charge coupled device (CCD) image sensor. The camera 113 performs photoelectric conversion on the light received by the imaging device and then performs analog/digital (A/D) conversion to generate an image. The camera 113 outputs the generated image to the controller 130.

The storage unit 120 is implemented by a storage device, such as a semiconductor memory device, such as a random access memory (RAM) or a flash memory. The storage unit 120 includes a content storage unit 121. The storage unit 120 stores information used for processing performed by the controller 130.

The content storage unit 121 stores AR content acquired from the server 200. FIG. 5 is a diagram illustrating an exemplary content storage unit. As illustrated in FIG. 5, the content storage unit 121 has the items “content identifier (ID)”, “content type”, “user ID”, “content” and “position information”. The content storage unit 121, for example, stores each set of AR content as one record.

A “content ID” is an identifier that identifies AR content. “Content type” is information indicating whether the AR content can be displayed only to a given user or to all users. When the “content type” is, for example, “common”, it is indicated that the AR content can be displayed to all users. When the “content type” is “individual”, it is indicated that the AR content can be displayed to a given user. A “user ID” is an identifier that identifies the given user to which the AR content can be displayed in the case where “individual” is in the “content type” column. The “content” is, for example, a data file forming the AR content. The “position information” is position information that is associated with the AR content. The “position information” is position information indicating information about a position in a global coordinate system of the associated AR content.

For example, a central processing unit (CPU) or a micro processing unit (MPU) uses a RAM as a work area and executes a program stored in an internal storage device, thereby implementing the controller 130. The controller 130 may be implemented by, for example, an integrated circuit, such as an application specific integrated circuit (ASIC) or a field programmable gate array (FPGA). The controller 130 includes a first detector 131, a second detector 132, a transmission controller 133, a distribution unit 134, and a display controller 135 and implements or executes functions and actions of the information processing to be described below. The internal configuration of the controller 130 is not limited to the configuration illustrated in FIG. 1. The controller 130 may have a different configuration as long as the configuration enables the information processing described below.

When the user issues an instruction to start an AR application, the first detector 131 starts the AR application. On starting the AR application, the first detector 131 executes, as pre-processing, acquiring position information and acquiring information about AR content in the vicinity of the terminal device 100. The first detector 131 outputs a detection instruction to the position detection sensor 112. In response to the detection instruction, position information and orientation information are input from the position detection sensor 112 to the first detector 131. In other words, the first detector 131 starts acquiring the position and orientation of the terminal device 100.

On the basis of the acquired position information, the first detector 131 generates an information acquisition request for acquiring information about AR content in the vicinity of the terminal device 100. The vicinity of the terminal device 100 may be the area of the pre-display area 23 in the radar chart 21 illustrated in FIG. 2, etc. The first detector 131 transmits the generated information acquisition request to the server 200 via the communication unit 110 and the network N. The information about the AR content acquired according to the information acquisition request is information, such as the content ID of the AR content in the vicinity of the terminal device 100, the content type, the user ID, and the position information. On receiving the information about the AR content from the server 200 via the network N and the communication unit 110, the first detector 131 stores the received information about the AR content in the content storage unit 121.

When the pre-processing ends, the first detector 131 determines whether a given event is detected. The given event is, for example, and event based on elapse of a given time, shift of the position of the terminal 100a by a given distance, or detection of a new wireless LAN access point. The given time may be, for example, ten seconds and the given distance may be, for example, 100 m. The first detector 131 updates the position information about the terminal 100a when a given event is detected and outputs a search instruction for searching for the terminal 100b together with the position information to the second detector 132. When no given event is detected, the first detector 131 does not update the position information about the terminal 100a and outputs a search instruction to search for the terminal 100b together with the position information to the second detector 132. The first detector 131 outputs the orientation information to the display controller 135.

When the position information and the search instruction are input from the first detector 131 to the second detector 132, the second detector 132 acquires information about the terminal 100b with which the terminal 100a is able to communicate from the terminal 100a. In other words, on the basis of the position of the terminal 100a obtained by performing positioning using signals of a global navigation satellite system, the second detector 132 detects whether there is a given terminal, that is, the terminal 100b, in a given concentric zone about the terminal 100a.

In other words, the second detector 132 determines whether there is the terminal 100b in the given concentric zone about the terminal 100a. The second detector 132 may acquire position information about the terminal 100b with which the terminal 100a is able to communicate from the terminal 100b and determine whether there is the terminal 100b in the given concentric zone on the basis of the position information about the terminal 100a and the acquired position information about the terminal 100b. The given concentric zone may be, for example, 30 to 50 m. In other words, the second detector 132 sets the pre-display area 23 corresponding to the given concentric zone and the display area 22 that is an area in the pre-display area 23 and in which AR content is displayed. The second detector 132 outputs the display area 22 and the pre-display area 23, which are set, to the transmission controller 133 and the display controller 135. In the following descriptions, the display area 22 and the pre-display area 23 may be collectively referred to as a display area.

When there is the terminal 100b in the given concentric zone about the terminal 100a, the second detector 132 determines whether communication between the terminal devices 100, that is, ad-hoc communication is permitted. In other words, the second detector 132 determines whether there is the terminal 100b satisfying a condition that the terminal 100b is in the given concentric zone about the terminal 100a and ad-hoc communication is permitted. When there is not the terminal 100b in the given concentric zone about the terminal 100a, the second detector 132 determines that there is not the terminal 100b satisfying the condition.

When there is the terminal 100b satisfying the condition, the second detector 132 refers the content storage unit 121 and extracts the content ID of the AR content whose corresponding data file has not been acquired. The second detector 132 outputs a request to distribute the AR content corresponding to the extracted content ID as a terminal-to-terminal distribution request together with the information about the terminal 100b with which the terminal 100b is able to communicate to the transmission controller 133.

When there is not the terminal 100b satisfying the condition, the second detector 132 refers to the content storage unit 121 and extracts the content ID of AR content whose corresponding data file has not been acquired. The second detector 132 outputs a request to distribute the AR content corresponding to the extracted content ID as a server distribution request to the transmission controller 133. The second detector 132 outputs the position information about the terminal 100a together with the terminal-to-terminal distribution request or the server distribution request to the transmission controller 133.

When there is the terminal 100b in the given concentric zone about the terminal 100a, the second detector 132 may output an instruction to refrain from performing the positioning process to the position detection sensor 112, In this case, when the terminal 100a is able to acquire the AR content from the terminal 100b in the vicinity, the terminal 100a need not transmit the position information to the server 200 and thus the terminal 100a may refrain from performing the positioning process. In other words, when the second detector 132 detects that there is a given terminal, that is, the terminal 100b, in the given concentric zone about the terminal 100a, the second detector 132 curbs execution of the process of specifying the position of the terminal 100a.

When a terminal-to-terminal distribution request and information about the terminal 100b with which the terminal 100a is able to communicate are input from the second detector 132 to the transmission controller 133, the transmission controller transmits the terminal-to-terminal distribution request via the communication unit 110 to the terminal 100b with which the terminal 100a is able to communicate. On receiving a data file forming the AR content according to the terminal-to-terminal distribution request from the terminal 100b with which the terminal 100a is able to communicate via the communication unit 110, the transmission controller 133 stores the received data file in the content storage unit 121.

The display area 22 and the pre-display area 23, which are set, are input from the second detector 132 to the transmission controller 133. On receiving the data file forming the AR content from the terminal 100b, the transmission controller 133 checks with the server 200 on whether there is insufficient AR content on the basis of the position information about the terminal 100a, the display area 22 and the pre-display area 23. Also on receiving information indicating that there is no data file that can be distributed from the terminal 100b, the transmission controller 133 checks with the server 200 on whether there is insufficient AR content on the basis of the position information about the terminal 100a and the display area.

In order to check whether there is insufficient AR content, for example, the transmission controller 133 generates a check request to check the content ID of AR content positioned in the pre-display area 23 about the position of the terminal 100a. The transmission controller 133 transmits the generated check request to the server 200 via the communication unit 110 and the network N.

The transmission controller 133 receives a response to the check request from the server 200 via the network N and the communication unit 110. The transmission controller 133 compares the content ID contained in the received response with the content ID whose corresponding data file is stored in the content storage unit 121 to determine whether there is insufficient AR content.

When there is insufficient AR content, the transmission controller 133 transmits a server distribution request containing the content ID of the insufficient AR content to the server 200 via the communication unit 110 and the network N. When a server distribution request is input from the second detector 132, the transmission controller 133 may transmit the input server distribution request to the server 200 via the communication unit 110 and the network N. On receiving a data file forming the AR content according to the server distribution request from the server 200, the transmission controller 133 stores the received data file in the content storage unit 121. In other words, the transmission controller 133 acquires the insufficient AR content from the server 200.

On acquiring the insufficient AR content from the server 200, or when there is no insufficient AR content, the transmission controller 133 outputs a display instruction to display the AR content together with the position information about the terminal 100a to the display controller 135.

In other words, in response to detection of a given event, the first detector 131 and the transmission controller 133 transmit a request to distribute AR content to the distribution server, that is, the server 200. On detecting that there is a given terminal, that is, the terminal 100b, in the given concentric zone about the terminal 100a, the second detector 132 and the transmission controller 133 transmits an request to distribute AR content to a given terminal, that is, the terminal 100b. When transmitting a distribution request to the given terminal, that is, the terminal 100b, the transmission controller 133 refrains from transmitting a distribution request to the distribution server, that is, the server 200. When specifying the position of the terminal 100a in response to detection of a given event, the first detector 131 and the transmission controller 133 transmit a request to distribute AR content corresponding to the specified position to the distribution server, that is, the server 200.

The distribution unit 134 receives and accepts the terminal-to-terminal distribution request from the terminal 100b via the communication unit 110. On accepting the terminal-to-terminal distribution request, the distribution unit 134 refers to the content storage unit 121 and acquires a data file forming the AR content with respect to the content ID whose corresponding content type is “common” among content IDs contained in the terminal-to-terminal distribution request. The distribution unit 134 transmits the acquired data file forming the AR content to the terminal 100b via the communication unit 110. The distribution unit 134 does not transmit the data file of the AR content that is not stored in the content storage unit 121 to the terminal 100b.

In other words, on accepting a request to distribute AR content from the terminal 100b, the distribution unit 134 refers to the content storage unit 121 that stores sets of AR content in association with types of the sets of AR content and acquires a given type of AR content. The distribution unit 134 transmits the acquired AR content to the terminal 100b.

The orientation information is input from the first detector 131 to the display controller 135 and the display area 22 and the pre-display area 23 are input from the second detector 132. Position information and a display instruction are input from the transmission controller 133 to the display controller 135. The display controller 135 sets the field-of-view 24 on the basis of the orientation information. The display controller 135 refers to the content storage unit 121 and determines whether there is AR content satisfying the display condition on the basis of the position information, the display area 22, the pre-display area 23 and the field-of-view 24. When there is AR content satisfying the display condition, the display controller 135 generates a display screen by displaying the AR content in a superimposed manner on a captured image that is input from the camera 113 and outputs the generated display screen to the display operation unit 111 to display the display screen. When there is no AR content satisfying the display condition, the display controller 135 generates a display screen from the captured image that is input from the camera 113 and outputs the generated display screen to the display operation unit 111 to display the display screen.

After outputting the display screen, the display controller 135 determines whether ending the AR application from the user is accepted. When the ending has not been accepted, the display controller 135 issues an instruction to continue detecting a given event to the first detector 131. On accepting the ending, the display controller 135 ends the AR application, that is, the transmission control process.

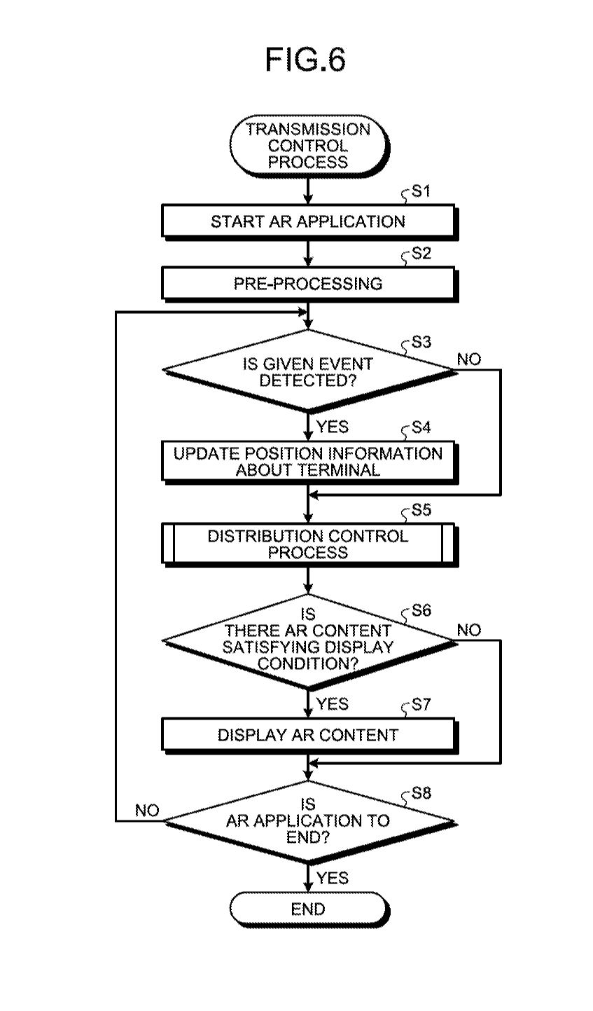

Operations of the transmission control system 1 according to the embodiment will be described. FIG. 6 is a flowchart illustrating an exemplary transmission control process according to the embodiment.

When the user issues an instruction to start the AR application, the first detector 131 of the terminal 100a starts the AR application (step S1). On starting the AR application, the first detector 131 executes, as the pre-processing, acquiring position information and acquiring information about AR content in the vicinity of the terminal 100a (step S2). The first detector 131 starts acquiring the position and orientation of the terminal 100a.

When the pre-processing ends, the first detector 131 determines whether a given event is detected (step S3). When the first detector 131 detects a given event (YES at step S3), the first detector 131 updates the position information about the terminal 100a (step S4) and outputs a search instruction to search for the terminal 100b, which is another terminal, together with the position information to the second detector 132. When no given event is detected (NO at step S3), the first detector 131 does not update the position information about the terminal 100a and outputs a search instruction to search for the terminal 100b together with the position information to the second detector 132. The first detector 131 outputs the orientation information to the display controller 135.

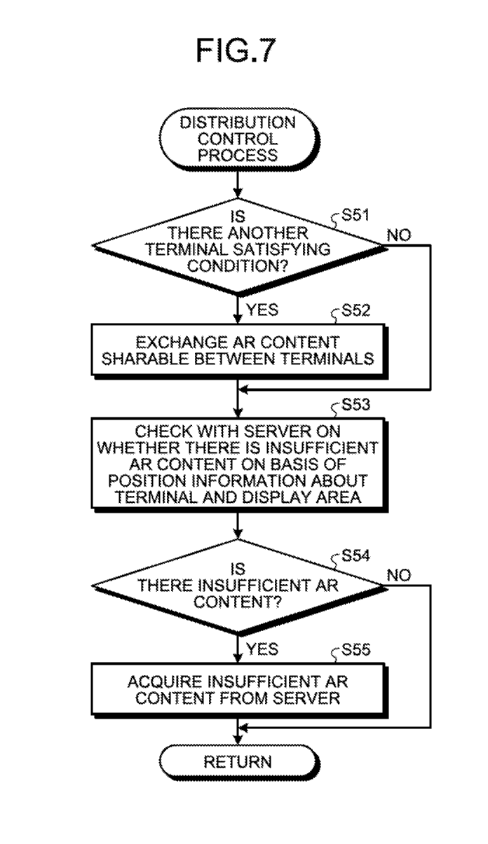

When the position information and the search instruction are input from the first detector 131 to the second detector 132, the second detector 132 cooperates with the transmission controller 133 to execute the distribution control process (step S5). The distribution control process will be described with reference to FIG. 7. FIG. 7 is a flowchart illustrating an exemplary distribution control process.

When the position information and the search instruction are input from the first detector 131 to the second detector 132, the second detector 132 determines whether there is the terminal 100b that satisfies the condition that the terminal 100b is in the given concentric zone about the terminal 100a and ad-hoc communication is permitted (step S51). The terminal 100b satisfying the condition is the terminal 100b with which the terminal 100a is able to communicate. The second detector 132 sets the display area 22 and the pre-display area 23 and outputs the display area 22 and the pre-display area 23, which are set, to the transmission controller 133 and the display controller 135. When there is not the terminal 100b satisfying the condition (NO at step S5), the second detector 132 goes to step S53.

When there is the terminal 100b satisfying the condition, the second detector 132 exchanges the sharable AR content with the terminal 100b (step S52). In other words, the second detector 132 outputs, to the transmission controller 133, a request to distribute insufficient AR content as a terminal-to-terminal distribution request together with the information about the terminal 100b with which the terminal 100a is able to communicate. When the terminal-to-terminal distribution request and the information about the terminal 100b with which the terminal 100a is able to communicate are input to the transmission controller 133, the transmission controller 133 transmits the terminal-to-terminal distribution request to the terminal 100b with which the terminal 100a is able to communicate.

On the other hand, the distribution unit 134 of the terminal 100b receives and accepts the terminal-to-terminal distribution request from the terminal 100a. According to the accepted terminal-to-terminal distribution request, the distribution unit 134 refers to the content storage unit 121 and acquires a data file forming the AR content insufficient in the terminal 100a. The distribution unit 134 transmits the acquired data file forming the AR content to the terminal 100a.

On receiving the data file forming the AR content according to the terminal-to-terminal distribution request from the terminal 100b, the transmission controller 133 of the terminal 100a stores the received data file in the content storage unit 121.

The transmission controller 133 checks with the server 200 on whether there is insufficient AR content on the basis of the position information about the terminal 100a and the display area (step S53). In order to check whether there is insufficient AR content, the transmission controller 133 generates a check request to check the content ID of AR content positioned in the pre-display area 23. The transmission controller 133 transmits the generated check request to the server 200.

The transmission controller 133 receives a response to the check request from the server 200. The transmission controller 133 compares the content ID contained din the received response with the content ID whose corresponding data file is stored in the content storage unit 121 and determines whether there is insufficient AR content (step S54).

When there is insufficient AR content (YES at step S54), the transmission controller 133 transmits a server distribution request containing the content ID of the insufficient AR content to the server 200. On receiving a data file forming the AR content according to the server distribution request from the server 200, the transmission controller 133 stores the received data file in the content storage unit 121. In other words, the transmission controller 133 acquires the insufficient AR content from the server 200 (step S55) and returns to the original process. When there is not any insufficient AR content (NO at step S54), the transmission controller 133 returns to the original process. Accordingly, the second detector 132 and the transmission controller 133 are able to acquire the insufficient AR content.

FIG. 6 will be referred back to and described. When the distribution control process ends, the transmission controller 133 outputs a display instruction to display the AR content together with the position information about the terminal 100a to the display controller 135.

The position information and the display instruction are input from the transmission controller 133 to the display controller 135. The display controller 135 refers to the content storage unit 121 and determines whether there is AR content satisfying the display condition on the basis of the position information, the display area 22, the pre-display area 23 and the field-of-view 24, which is set (step S6). When there is AR content satisfying the display condition (YES at step S6), the display controller 135 generates a display screen by displaying the AR content in a superimposed manner on a captured image that is input from the camera 113 and outputs the generated display screen to the display operation unit 111 to display the display screen (step S7).

When there is not any AR content satisfying the display condition (NO at steps S6), the display controller 135 generates a display screen from the captured image that is input from the camera 113 and outputs the generated display screen to the display operation unit 111 to display the display screen.

When the display controller 135 outputs the display screen, the display controller 135 determines whether ending the AR application is accepted from the user (step S8). When the ending is not accepted (NO at step S8), the display controller 135 returns to step S3. When the ending is accepted (YES at step S8), the display controller 135 ends the AR application, that is, ends the transmission control process. Accordingly, the terminal 100a acquires the AR content from the terminal 100b and acquires the insufficient AR content from the server 200, which enables curbing the power consumption of communication with the server 200. Furthermore, the transmission control system 1 is able to reduce the load of simultaneous access by multiple users to the server 200. Even when the terminal 100a is not able to connect to the server 200, the terminal 100a is able to acquire AR content from the terminal 100b, which is another terminal, in the vicinity, which enables continuous display of AR content. The terminal 100a acquires data used to display AR content in the vicinity, which enables reducing the amount of an excess of communication relating to AR content.

As described above, in response to detection of a given event, the terminal device 100 transmits a distribution request to distribute AR content to the distribution, server (the server 200). On detecting that there is a given terminal (the terminal 100b) in a concentric zone about the terminal 100a, the terminal device 100 transmits the request to distribute AR content to the given terminal (the terminal 100b). As a result, the terminal device 100 is able to curb power consumption.

When transmitting the distribution request to the given terminal (the terminal 100b), the terminal device 100 refrains from transmitting the distribution request to the distribution server (the server 200). As a result, the terminal device 100 is able to reduce the amount of communication with the distribution server (the server 200) and thus curb power consumption.

On accepting the distribution request to distribute AR content from another terminal (the terminal 100b), the terminal device 100 refers to the content storage unit 121 that stores sets of AR content with types of the sets of AR content and acquires a given type of AR content. The terminal device 100 transmits the acquired AR content to another terminal (the terminal 100b). As a result, the terminal device 100 is able to share AR content with another user in the vicinity.

When the terminal 100a specifies its position in response to detection of an event, the terminal 100a transmits a distribution request to distribute AR content corresponding to the specified position to the distribution server (the server 200). When the terminal 100a detects that there is a given terminal (the terminal 100b, which is another terminal) in a given concentric zone about the terminal 100a, the terminal 100a refrains from executing a process of specifying the position of the terminal 100a. As a result, the terminal device 100 is able to curb the power consumption relating to positioning.

The terminal 100a determines whether there is a given terminal (the terminal 100b, which is another terminal) in a given concentric zone about the terminal 100a on the basis of the position of the terminal 100a obtained by performing positioning using signals of a global navigation satellite system. As a result, the terminal 100a is able to specify its position and the given concentric zone accurately.

The given event is an event based on elapse of a given time or shift of the position of the terminal 100a. As a result, the terminal device 100 is able to display AR content corresponding to the position of the terminal 100a.

The above-described embodiment exemplifies checking equipment in a factory; however, the embodiments are not limited thereto. For example, the embodiment may be applied to, for example, a guide to places of interest in a tourist spot or games using position information.

The above-described embodiment exemplifies AR content that can be displayed to a specific user; however, the AR content includes, for example, paid AR content or AR content displayed to a user who satisfies a given condition.

In the above-described embodiment, AR content is shared and exchanged between the terminal devices 100 of the users; however, the embodiments are not limited thereto. For example, AR content in the vicinity of a wireless LAN access point may be acquired from the server 200 and the AR content may be shared and exchanged between the terminal 100a and the wireless LAN access point.

The above-described embodiment exemplifies communication between the terminal devices 100 using a wireless LAN; however, the embodiments are not limited thereto. For example, near field communication, such as Bluetooth, may be used.

In the above-described embodiment, the number of hops of ad-hoc communication between the terminal devices 100 is “1”; however, the embodiments are not limited thereto. The number of hops may be “2” or larger. For example, the terminal 100a and the terminal 100b may perform ad-hoc communication. In this example, the number of hops of ad-hoc communication is “2”.

The components of each unit illustrated in the drawings need not necessarily be configured physically as illustrated in the drawings. In other words, specific modes of dispersion and integration among units are not limited to those illustrated in the drawings. All or part of the units may be distributed or integrated functionally or physically according to a given unit in accordance with various types of load and the usage. For example, the functions of the transmission controller 133 may be allocated to and integrated with the first detector 131 and the second detector 132. The steps illustrated in the drawings are not limited to the above-described order. The steps may be performed simultaneously or may be performed in a different order as long as no inconsistency is caused in the content of the steps.

All or part of various processing functions implemented in the devices may be implemented on a CPU (or a microcomputer, such as a MPU or a micro controller unit (MCU)). Obviously, all or given part of the various processing functions may be implemented by a program that is analyzed and executed by a CPU (or a microcomputer, such as a MPU or a MCU) or by hardware using a wired logic.

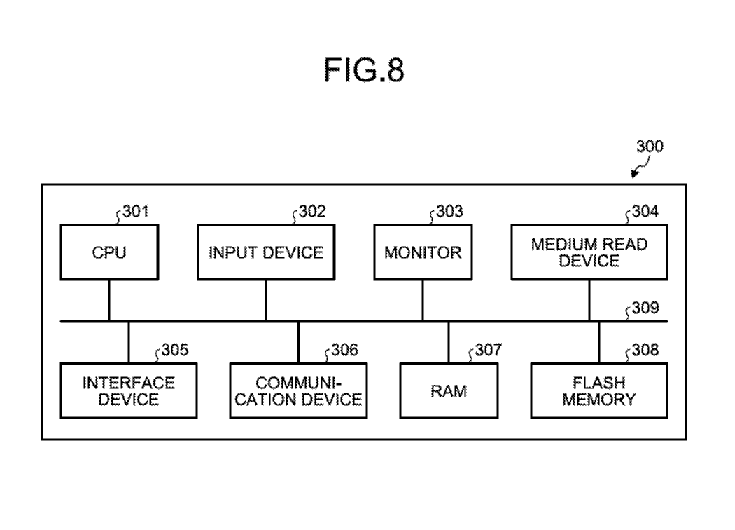

It is possible to implement the various processes described in the above-described embodiments by executing a program, prepared in advance, with a computer. An exemplary computer that executes a program having the same functions as those of the above-described embodiment will be described below. FIG. 8 is a diagram illustrating an exemplary computer that executes a transmission control program.

As illustrated in FIG. 8, a computer 300 includes a CPU 301 that executes various types of computing, an input device 302 that receives data inputs, and a monitor 303. The computer 300 includes a medium read device 304 that reads a program, etc., from a storage medium, an interface device 305 for connection with various devices, and a communication device 306 for connection with other information processing devices by wired or wireless connection. The computer 300 further includes a RAM 307 and a flash memory 308 that temporarily store various types of information. Each of the devices 301 to 308 is connected to a bus 309.

A transmission control program having the same functions as those of the processors of the first detector 131, the second detector 132, the transmission controller 133, the distribution unit 134 and the display controller 135 illustrated in FIG. 1 is stored in the flash memory 308. The content storage unit 121 and various types of data for implementing the transmission control program are stored in the flash memory 308. The input device 302 receives inputs of various types of information, such as operation information, from the user of the computer 300. The monitor 303 displays, for example, various screens, such as a display screen, to the user of the computer 300. For example, a headphone is connected to the interface device 305. The communication device 306 has the same functions as those of the communication unit 110 illustrated in FIG. 1 and is connected to the network N or the terminal 100b, which is another terminal, to communicate various types of information with the server 200 or the terminal 100b.

The CPU 301 reads each program that is stored in the flash memory 308, loads the program into the RAM 307, and executes the program to perform various types of processing. The programs enable the computer 300 to function as the first detector 131, the second detector 132, the transmission controller 133, the distribution unit 134 and the display controller 135 illustrated in FIG. 1.

The above-described transmission control program need not necessarily be stored in the flash memory 308. For example, the computer 300 may read and execute the program that is stored in a storage medium that is readable by the computer 300. The storage medium readable by the computer 300 corresponds to, for example, a portable recording medium, such as a CD-ROM, a DVD disk, or a universal serial bus (USB) memory, a semiconductor memory, such as a flash memory, or a hard disk drive. The transmission control program may be stored in a device that is connected to, for example, a public line, the Internet or a LAN and the computer 300 may read the transmission control program from the device and execute the transmission control program.

According to the embodiment, it is possible to curb power consumption of a terminal.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable recording medium having stored therein a program that causes a computer to execute a process of transmitting a distribution request to distribute AR content to a distribution server in response to detection of a given event, the process comprising:
transmitting a distribution request to distribute AR content to a given terminal when it is detected that there is the given terminal in a given concentric zone about a terminal.

2. The non-transitory computer readable recording medium according to claim 1, wherein the transmitting includes, when transmitting the distribution request to the given terminal, refraining from transmitting the distribution request to the distribution server.

3. The non-transitory computer readable recording medium according to claim 1, wherein the process further comprises:
on receiving a distribution request to distribute AR content from another terminal, referring to a storage unit that stores sets of AR content in association with types of the sets of AR content and acquiring a given type of AR content; and
transmitting the acquired AR content to the another terminal.

4. The non-transitory computer readable recording medium according to claim 1, wherein the transmitting includes, when specifying a position of the terminal in response to detection of a given event, transmitting a distribution request to distribute AR content corresponding to the specified position to the distribution server and, when it is detected that there is the given terminal in the given concentric zone about the terminal, refraining from executing the specifying the position of the terminal.

5. The non-transitory computer readable recording medium according to claim 1, wherein the process further comprises detecting whether there is the given terminal in the given concentric zone about the terminal on the basis of a position of the terminal obtained by performing positioning using signals of a global navigation satellite system.

6. The non-transitory computer readable recording medium according to claim 1, wherein the given event is an event based on any one of elapse of a given time and shift of a position of the terminal.

7. A transmission control method executed by a computer to transmit a distribution request to distribute AR content to a distribution server in response to detection of a given event, the method comprising:
transmitting a distribution request to distribute AR content to a given terminal when it is detected that there is the given terminal in a given concentric zone about a terminal, using a processor.

8. The transmission control method according to claim 7, wherein the transmitting includes, when transmitting the distribution request to the given terminal, refraining from transmitting the distribution request to the distribution server.

9. The transmission control method according to claim 7, further comprising:
on receiving a distribution request to distribute AR content from another terminal, referring to a storage unit that stores sets of AR content in association with types of the sets of AR content and acquiring a given type of AR content, using the processor; and
transmitting the acquired AR content to the another terminal, using the processor.

10. The transmission, control method according to claim 7, wherein the transmitting includes, when specifying a position of the terminal in response to detection of a given event, transmitting a distribution request to distribute AR content corresponding to the specified position to the distribution server and, when it is detected that there is the given terminal in the given concentric zone about the terminal, refraining from executing the specifying the position of the terminal.

11. The transmission control method according to claim 7, further comprising detecting whether there is the given terminal in the given concentric zone about the terminal on the basis of a position of the terminal obtained by performing positioning using signals of a global navigation satellite system, using the processor.

12. The transmission control method according to claim 7, wherein the given event is an event based on any one of elapse of a given time and shift of a position of the terminal.

13. An information processing device that transmits a distribution request, to distribute AR content to a distribution server in response to detection of a given event, the information processing device comprising:
a memory; and
a processor coupled to the memory, wherein the processor executes a process comprising:
detecting whether there is a given information processing device in a given concentric zone about the information processing device; and
transmitting a distribution request to distribute AR content to a given information processing device when it is detected that there is the given information processing device in the given concentric zone about an information processing device.

14. The information processing device according to claim 13, wherein the transmitting includes, when transmitting the distribution request to the given information processing device, refraining from transmitting the distribution request to the distribution server.

15. The information processing device according to claim 13, wherein the processor executes the process comprising:
distributing, on receiving a distribution request to distribute AR content from another information processing device, refers to a storage unit that stores sets of AR content in association with types of the sets of AR content, acquires a given type of AR content, and transmits the acquired AR content to the another information processing device.

16. The information processing device according to claim 13, wherein the transmitting includes, when specifying a position of the information processing device in response to detection of a given event, transmitting a distribution request to distribute AR content corresponding to the specified position to the distribution server and, when detecting there is the given information processing device in the given concentric zone about the information processing device, refrains from executing the specifying the position of the information processing device.

17. The information processing device according to claim 13, wherein the detecting includes, detecting whether there is the given information processing device in the given concentric zone about the information processing device on the basis of a position of the information processing device obtained by performing positioning using signals of a global navigation satellite system.

18. The information processing device according to claim 13, wherein the given event is an event based on any one of elapse of a given time and shift of a position of the information processing device.
